(19) United States
(12) Patent Application Publication
(10) Pub. No.: US 2026/0001265 A1
(43) Pub. Date: Jan. 1, 2026

(54) RECYCLABLE FILM WITH BARRIER LAYER

(71) Applicant: RKW SE, Mannheim (DE)

(72) Inventors: Adrien Dembowski, Mannheim (DE); Claudia SPICKER, Mannheim (DE); Christoph SCHWEITZE, Mannheim (DE); Marcus WAGEL, Mannheim (DE); Florian GLASEDONNER, Mannheim (DE); Luc HERMANS, Mannheim (DE); Konrad NONIEWICZ, Mannheim (DE); Leonhard MAIER, Babensham (DE); Thomas STROH, Mannheim (DE); Claudia BENDER, Mannheim (DE)

(73) Assignee: RKW SE, Mannheim (DE)

(21) Appl. No.: 18/880,924

(22) PCT Filed: Jul. 3, 2023
(86) PCT No.: PCT/EP2023/068218

§ 371 Date: Jan. 3, 2025

(30) Foreign Application Priority Data
Jul. 4, 2022 (DE) 102022116668.6

(51) Int. Cl. B29C 48/19; B29C 48/00; B29C 48/22; B29K 23/00; B29K 77/00; B29K 96/02; B29L 7/00; B29L 9/00

(52) U.S. Cl. CPC B29C 48/19; B29C 48/0017; B29C 48/0018; B29C 48/0019; B29C 48/022; B29C 48/22; B29C 2795/007; B29K 2023/065; B29K 2023/086; B29K 2077/00; B29K 2096/02; B29K 2995/0012; B29K 2995/0024; B29K 2995/0051; B29K 2995/0063; B29K 2995/0067; B29K 2995/0069; B29K 2995/0088; B29K 2995/0097; B29L 2007/008; B29L 2009/00

(57) ABSTRACT

A multilayer, monoaxially stretched, recyclable film (1) for a laminate (7). The film (1) has outer layers (3) and at least one inner barrier layer (6), with a tie layer (5) arranged between each of these. At least one further, functional intermediate layer (4) is arranged between each of the outer layers (3) and the barrier layer (6).

### CROSS REFERENCE TO RELATED APPLICATIONS

This application is a 371 National Phase of PCT/EP2023/068218, filed Jul. 3, 2023, which claims priority from German Patent Application No 10 2022 116 668.6, filed Jul. 4, 2022, both of which are incorporated herein by reference as if fully set forth.

### TECHNICAL FIELD

The invention relates to a multilayer, monoaxially stretched, recyclable film for a laminate, wherein the film has outer layers and at least one inner barrier layer, with a tie layer arranged between each of them.

### BACKGROUND

Current, commercially available plastic packaging often consists of film laminates made of different layers, which are customised with regard to their application and function, e.g. polyolefins such as polyethylene (PE) and/or polypropylene (PP), often combined with polyethylene terephthalate (PET) and/or polyamide (PA). In addition, laminates made of different plastic layers are usually combined with materials such as aluminium or paper.

Polyethylene has proven its worth in the manufacture of food packaging films, food bags, stretch films, shrink films, bin liners and mailing bags. In particular, the packaging of prepared and/or raw foods requires protective films with sufficiently low water vapour and oxygen transmission rate.

At the same time, the way in which plastic, and therefore also food packaging film, is currently produced and disposed of can also be harmful to the environment under certain circumstances. The consequences range from high CO2 emissions to pollution of the oceans. To counteract this, the European Union wants to reduce the landfilling of plastic waste as part of its Green Deal. By 2030, 55% of plastic packaging waste is to be recycled.

In order to meet the challenges of recycling, the design of packaging must become increasingly sustainable. This can be achieved, for example, by realising and implementing more mono-material designs. The challenge here is to realise the very different properties of packaging, which were previously achieved by combining different plastic layers with different material bases, with just one recyclable mono-material construction.

Such typical properties and therefore also requirements for a packaging laminate are the barrier with regard to water vapour, oxygen and aroma penetration. Although polyethylene films can form a sufficient barrier for water vapour due to their hydrophobic nature, they must also be combined with additional layers or materials in order to improve the oxygen barrier property. This function can be achieved in a packaging laminate using an aluminium barrier layer and/or a suitable barrier polymer, such as ethylene vinyl alcohol copolymer (EVOH) and/or polyamide (PA).

Packaging is usually also provided with a print that is visible from the outside. For this purpose, the packaging laminates are made from at least two films, whereby one film is ideally adapted as a carrier film for the print, while the other film is realised as a sealing film including a barrier layer.

EP 0 673 759 B1 already describes a multilayer packaging film consisting of a heat-sealing layer, layers of LLDPE, adhesive layers (and a barrier layer of EVOH, whereby the multilayer film was drawn biaxially in the machine direction and in the transverse direction with a stretch ratio of about 10.

EP 2 106 342 B1 discloses a multilayer film comprising an ethylene-vinyl alcohol copolymer (EVOH) layer having a first surface and a second surface, a first tie layer adhesive bonded to the first surface and a second tie layer adhesive bonded to the second surface of the EVOH layer, at least one layer of a high density polyethylene bonded to the first tie layer, and at least one polyethylene layer selected from the group consisting of a linear low density polyethylene and a high density polyethylene bonded to the second tie layer, wherein the multilayer film is subsequently uniaxially bonded to the first tie layer, selected from the group consisting of a linear low density polyethylene and a high density polyethylene, bonded to the second tie layer, wherein the multilayer film is subsequently uniaxially oriented in the processing direction with a draw ratio of more than 5, and wherein the subsequently oriented film has a water vapour transmission rate of less than 3.5 g-mil/m2-day and an oxygen transmission rate of less than 2.5 cm3-mil/m2-day.

EP 3 481 630 B1 describes a recyclable polyethylene film made of at least 80% polyethylene material and a maximum of 20% compatible polyolefin material, wherein the polyethylene film is less than 40 μm thick and has a central layer of linear low-density polyethylene and/or linear metallocene low-density polyethylene and two outer layers of high-density polyethylene connected to the central layer and surrounding the central layer, wherein the HDPE content of the polyethylene film is at least 60% by volume, preferably at least 70% by volume, most preferably at least 80% by volume, and wherein the polyethylene film is stretched in at least one direction and the two outer layers together are at least three times as thick, preferably at least four times as thick, as the central layer. In this film, polypropylene or cyclo-olefin copolymer must be mixed into the outer layers in order to achieve sufficient heat resistance, which means that a monomaterial construction is no longer realised.

EP 2 860 031 B1 discloses a multilayer film stretched in the machine direction and suitable for labels, comprising a core layer and two outer layers sandwiched around the core layer, wherein the core layer comprises a bimodal ethylene/1-butene/C6-C12-alpha-olefin terpolymer with a density between926 kg/m3to 950 kg/m3 and the two outer layers comprise unimodal HDPE with a density of more than 940 kg/m3 up to 970 kg/m3.

WO 2018/202479 A1 and WO 2020/038579 A1 disclose inventions of asymmetrically constructed and recyclable, easily tearable packaging laminates with a good barrier effect. The packaging laminates comprise a first laminate layer and a second laminate layer, wherein the first laminate layer is a co-extruded and machine-stretched composite of a substrate layer with an HDPE content of at least 60% by volume, a tie layer and a barrier layer of a barrier polymer, preferably of polyamide or ethylene-vinyl alcohol copolymer, with a thickness of at most 20% of the total thickness of the first laminate layer. The tie layer is located between the substrate layer and the barrier layer and the first laminate layer is bonded to the second laminate layer at its barrier layer. The packaging laminate has excellent tear resistance in both directions, but this is not desirable in all packaging solutions.

The combination of the barrier function with the requirements of sealing significantly limits the choice of possible sealing layers and poses major challenges in the production of laminates for packaging.

High-quality packaging laminates also usually have an imprint that is realised using a line printing process, e.g. gravure printing or flexographic line printing. For this reason, PET or PP film webs are often used as the printed film web in such film laminates. Currently, printed film webs with layer thicknesses of just 12 μm are used for this purpose. However, the construction of monolaminates made of polyethylene causes the problem of qualitative printability with such low layer thicknesses.

### SUMMARY

The object of the present invention is to provide a film for a laminate that fulfils the requirements of a monomaterial construction and can guarantee sufficient barrier properties. It should be possible to print the film cheaply and in excellent quality. To this end, the film should be particularly stiff and have sufficient toughness. In addition, the film should have sufficient heat resistance. At least one film of the laminate should have the necessary sealing properties. The film should be harmless to health and ecologically sustainable. In addition, the film should not emit any odours.

According to the invention, this object is ensured by a film for a laminate according to the main claim. Preferred variants can be found in the subclaims, the description and the drawings.

According to the invention, at least one further functional intermediate layer is arranged between the outer layers and the barrier layer.

The intermediate layer has to fulfil a number of functions. Ideally, it ensures a favourable toughness and at the same time a very stiff formation of the film. This is the only way to ensure that a high-quality print image can be applied to the very thin film of the laminate.

In a particularly favourable variant, two functional intermediate layers are arranged on top of each other, which further enhances the advantageous mechanical properties.

For better adhesion of a high-quality print, the outer layers of the film are made of HDPE, which may also have a proportion of additives. The density of the HDPE of the outer layers ideally has a value of more than 0.941 g/cm³, preferably more than 0.943 g/cm³, in particular more than 0.945 g/cm³.

For example, the density of the HDPE of the outer layers is less than 0.97 g/cm³, preferably less than 0.965 g/cm³ and/or its melt flow rate (at 190° C. at 21.6 kg) according to ISO 1133-1 is more than 5 g/10 min, preferably more than 10 g/10 min and/or less than 25 g/10 min, preferably less than 20 g/10 min.

In a variant of the invention, one of the outer layers or both outer layers may have a small proportion of additives. For example, the proportion of additives in one outer layer is more than 0.5% by weight, preferably more than 1.0% by weight, in particular more than 1.5% by weight and/or less than 3.5% by weight, preferably less than 3.0% by weight, in particular less than 2.5% by weight.

For example, the additives can include a highly transparent silica-based anti-block and IR filter masterbatch in PE carrier resin and/or a processing aid for levelling the flowability of the melt.

In one variant of the invention, the D97.5 of an additive is less than 12 μm, preferably less than 9 μm, in particular less than 6 μm. As a result, for example, an excellent antiblocking effect is still realised and at the same time the barrier property of the film is particularly supported and/or protected.

Advantageously, the outer layers have a higher density by a factor than the functional intermediate layers, the value of the factor being more than 1.002, preferably more than 1.005, in particular more than 1.008 and/or less than 1.20,preferably less than 1.15, in particular less than 1.10.

In a particularly advantageous variant of the invention, the functional intermediate layers have a density with a value of more than 0.91 g/cm³, preferably of more than 0.92 g/cm³, in particular of more than 0.93 g/cm³ and/or of less than 0.940 g/cm³, preferably of less than 0.939 g/cm³, in particular of less than 0.938 g/cm³.

The flow behaviour of polyolefins is described using the melt flow rate according to ISO 1133-1, usually at a temperature of 190° C. for polyethylene and 230° C. for polypropylene at a load of 2.16 kg, 5 kg or 21.6 kg. A higher melt flow index correlates with a lower average molecular weight of the polymer. At the same time, the higher the melt index of a polymer, the lower the melt viscosity, which is favourable for a high output of the extrusion system. On the other hand, polymers with a high molecular weight, i.e. a low melt index, are advantageous in terms of mechanical stability, in particular tensile strength and toughness.

Ideally, the HDPE of the outer layers has a melt flow rate according to ISO 1133-1 of more than 1.0 g/10 min, preferably more than 1.25 g/10 min, in particular more than 1.5 g/10 min and/or less than 3.0 g/10 min, preferably less than 2.0 g/10 min, in particular less than 1.75 g/10 min at 190° C. and 5 kg. Furthermore, the melt flow rate is more than 11 g/10 min, preferably more than 13 g/10 min, in particular more than 15 g/10 min and/or less than 30 g/10 min, preferably less than 20 g/10 min, in particular less than 17 g/10 min at 190° C. and 21.6 kg.

Preferably, the high-density polyethylene has a medium molecular weight and a particularly narrow molecular weight distribution, which leads to good bubble stability and processability. Furthermore, the outer layers have excellent tensile strength and good elongation at break with a low tendency to fibrillate.

For example, the high-density polyethylene has a tensile elasticity of more than 880 MPa, a tensile strength of more than 20 MPa and a melting temperature of more than 129° C. These special physical parameters result in a film that can fulfil the task at hand.

In an alternative variant of the invention, the high density HDPE has a melt flow rate according to ASTM D1238 of more than 0.1 g/10 min, preferably of more than 0.5 g/10 min, in particular of more than 0.8 g/10 min and/or less than 3.0 g/10min, preferably of less than 2.0 g/10 min, in particular of less than 1.0 g/10 min at 190° C. and 2.16 kg. For example, this high-density HDPE has a density of more than 0.961 g/cm³ according to ASTM D792 and a tear strength according to Elmendorf of more than 40 g in MD and more than 165 g in TD.

Advantageously, the polyethylene of the functional intermediate layers has a melt flow rate according to ISO 1133-1 of more than 1.0 g/10 min, preferably of more than 1.5 g/10 min, in particular of more than 1.9 g/10 min and/or less than 4.0g/10 min, preferably of less than 3.0 g/10 min, in particular of less than 2.1 g/10 min at 190° C. and 5 kg.

Furthermore, the melt flow rate of the polyethylene of the functional intermediate layers is more than 20 g/10 min, preferably more than 30 g/10 min, in particular more than 40 g/10 min and/or less than 65 g/10 min, preferably less than 55 g/10 min, in particular less than 45 g/10 min at 190° C. and 21.6 kg. As a result, the polyethylene in the intermediate layers as well as in the film achieves high toughness and simultaneously high stiffness values.

In a variant of the invention, the functional intermediate layers are formed from a bimodal polyethylene, preferably from a bimodal terpolymer, in particular from a bimodal ethylene/1-butene/C-C₆₁₂-alpha-olefin terpolymer. The combination of polymer chains with a low molecular weight and high density and those with a high molecular weight and low density leads to a combination of stiffness and flexibility in the polyethylene of the functional intermediate layers. This enables an optimal balance between strength, impact resistance, stiffness and processability of the resulting polyethylene functional intermediate layer.

Ideally, the barrier layer is formed as an ethylene-vinyl alcohol copolymer layer (EVOH). As the barrier properties of EVOH are higher than those of polyamide and PVDC, it is possible to keep the thickness of the barrier layer low and stretched. This makes it possible to produce a recyclable laminate in which the barrier layer amounts to a maximum of 5% of the total mass of the packaging laminate, which means that the laminate with barrier properties can be considered a mono-material construction.

Advantageously, the density of the tie layers has a value of less than 0.915 g/cm³, preferably less than 0.910 g/cm³, in particular less than 0.905 g/cm³. The tie layers are based on an LLDPE grafted with maleic anhydride and improve the adhesion between the PE layers and the EVOH layer in blown film production.

In a particularly favourable variant of the invention, the tie layer is formed from a polyethylene whose density is more than 0.880 g/cm³, preferably more than 0.900 g/cm³ and/or less than 0.940 g/cm³, preferably less than 0,920 g/cm³ and/or whose melt flow rate (at 190° C. at 2.16 kg) according to ASTM D 1238 is more than 0.1 g/10 min, preferably more than 1.0 g/10 min and/or less than 5.0 g/10 min, preferably less than 3.0 g/10 min.

Ideally, the melt flow rate (at 190° C. at 2.16 kg) according to ASTM D 1238 of the tie layer is similar to the melt flow rate of the functional intermediate layer. The melt flow rates of the tie layer and the functional intermediate layer differ by a factor of less than 1.5, preferably less than 1.4, in particular less than 1.3. This improves in particular the adhesion and embedding of the barrier in the polyethylene layer composite and represents an essential inventive feature of the laminate construction.

The haze value is a measure of the haze or gloss of transparent films. The method for measuring the haze value is described in the ASTM D 1003 standard and DIN EN ISO 2813. Favourably, the film has a gloss according to DIN EN ISO 2813 of less than 7%, preferably less than 6%, in particular less than 5%. This gives the laminate and the film a particularly high-quality appearance.

The gas transmission rate of films is determined in accordance with DIN EN ISO 2556 under atmospheric pressure. A test specimen made of a film separates two chambers, one of which contains the test gas at atmospheric pressure, while air is evacuated from the other with a known initial volume until a near vacuum is reached. The amount of gas flowing through the test specimen from one chamber to the other is determined as a function of time by measuring the pressure increase in the second chamber with a manometer.

Advantageously, the film has an oxygen transmission rate of less than 10 cm³/m³-day-bar, preferably less than 6 cm³/m³-day-bar, in particular less than 2 cm³/m³-day-bar, measured at 23° C. and 0% rH. The film and the packaging laminate therefore have excellent barrier properties for storing sensitive foods.

The water vapour transmission rate of dry or moisture-sensitive goods is determined in accordance with DIN 53116 using a gravimetric measurement method. A test container filled with a desiccant is sealed with a sample of film and exposed to a defined test climate. The amount of water permeating through the sample is determined by weighing. A quantity of water in a range of 1-200 g/(m²-d) can be detected. The detection limit is also dependent on the composition and thickness of the sample.

In a particularly advantageous variant of the invention, the film has a water vapour transmission rsate of less than 50 g/m², preferably of less than 25 g/m², in particular of less than 5 g/m² in 24 h according to ASTM D6701-01. This makes the film and the laminate particularly advantageous for packaging perishable foodstuffs.

Advantageously, the film is stretched monoaxially in the machine direction by more than a factor of 2.0, preferably by more than a factor of 3.0, in particular by more than a factor of 4.0 and/or stretched by less than a factor of 7.0,preferably by less than a factor of 6.5, in particular by less than a factor of 6.0. Among other things, the stretching gives the film its particularly favourable mechanical properties.

The film according to the invention is ideally designed as a carrier film for imprints combined with excellent barrier properties. The special selection of polymers as well as the design in a seven-or nine-layer variant realise a particularly thin film, which nevertheless has convincing mechanical properties, even in the design of a monomaterial construction. Despite the thin design, the stiffness and simultaneous toughness, which are realised in particular by the functional intermediate layers, lead to excellent printability. In addition, the barrier function, which is usually integrated into the sealing layer, is already realised in the carrier film, which makes it possible to select particularly thin sealing layers that can be sealed at low temperatures.

A film made of pure HDPE as described in DE 10 2005 003922A 1 would be just stiff enough for printing and heat resistant, but not tough enough for use as a laminate and would tend to splice in the direction of stretching. The film structure according to the invention with the functional intermediate layers makes it possible to combine these quite contradictory properties.

Flexographic printing is a frequently used process for printing on film. This is a direct letterpress process, which is also known as a web-fed rotary printing process. The flexible printing plates, which are made of photopolymer or rubber, are used in combination with low-viscosity printing inks. The raised areas of the printing plate are image-bearing. The advantages lie in the economic efficiency through the utilisation of a large printing width and a high printing speed, as well as the availability of cost-effective printing inks. The printing tools essentially consist of photopolymer printing plates and/or laser-engraved elastomer sleeves. Large print runs can be realised economically with flexographic printing.

In a particularly advantageous variant, an imprint is arranged directly on an outer layer of the film. The imprint can be arranged on the side facing away from the packaged goods or as a counter-print between the film and the layer. The imprint can be designed as a print motif. In the film sector, the term print motif refers to the thematic design part of an imprint. If necessary, print motifs that characterise the manufacturer can also be included in the scope of the print.

Preferably, the imprint is applied to an outer layer of the film using a flexographic printing process, whereby all conventional printing processes are in principle suitable for this purpose and are expressly included in the invention.

The thickness of the film was measured in accordance with DIN 53370and specified as an average value. Advantageously, the film has a thickness of less than 60 μm, preferably less than 50 μm, in particular less than 40 μm and/or more than 5 μm, preferably more than 10 μm, in particular more than 15 μm. The film is thus designed to be as thin and material-saving as possible, so that it is nevertheless suitable for the application of a high-quality print.

In a particularly favourable variant of the invention, the multilayer structure of the film is symmetrical, which means that the printability of both outer layers can be realised and can therefore be varied flexibly between the printing arrangement on the outside or the reverse printing.

To realise the recyclability and thus also the sorting in modern waste separation plants, such as the float-sink process, the density of the film is less than 0.99 g/cm³, preferably less than 0.98 g/cm³, in particular less than 0.97 g/cm³ and/or more than 0.60 g/cm³, preferably more than 0.70 g/cm³, in particular more than 0.80 g/cm³.

Heat sealing is a common method for producing seals and seams on flexible packaging. Adhesive systems are also occasionally used. There are a variety of types of heat sealing. The most common, especially for films, are heat sealing, bar sealing and impulse sealing.

Suitable film layers for heat-sealing are LDPE and LLDPE, which can then be sealed with the film to form a laminate. LDPE has better heat-sealing properties than LLDPE. It seals at lower temperatures, seals over a wider temperature range and has better heat tack, which is largely due to the long-chain branching. Metallocene LLDPE with higher alpha olefins was developed to overcome this disadvantage of LLDPE. Another approach to achieving the best blend of properties for a particular application is to blend LLDPE and LDPE.

Thermal sealing uses two heated bars that exert pressure on the films to be sealed and simultaneously conduct heat to the interface, causing the films to melt at these points. The pressure ensures good contact between the films and supports the penetration of the molten viscous materials at the interface. After sufficient sealing time, the pressure is released from the bars and the films are released. Therefore, the hot tack of the film material is critical to the formation of an adequate seal. The full strength of the seal forms as the film material cools, but the initial strength must be sufficient to maintain the integrity of the seal during cooling.

The sealing bars usually have rounded edges to avoid puncturing the material, and often one bar is provided with a resilient surface to ensure even pressure during sealing. The sealing jaws are usually not flat but serrated and produce a patterned seal. In variants of thermal sealing, only one bar is heated and the other is not. Another variant uses heated rollers instead of bars, for example a bag is sealed as it passes through the rollers.

In order to design a film with particularly advantageous sealing properties, at least one outer layer and/or outer layer has a proportion of polypropylene, the proportion being more than 5% by weight, preferably more than 10% by weight, in particular more than 15% by weight, and/or less than 50% by weight, preferably less than 40% by weight, in particular less than 30% by weight. The proportion of polypropylene increases the heat resistance and thus also the temperature at which the film can be sealed without undermining the recyclability of the film.

Ideally, the layer has a thickness of more than 10 μm, preferably more than 15 μm, in particular more than 20 μm and/or less than 100 μm, preferably less than 80 μm, in particular less than 60 μm. Thus, depending on the use of the polyethylene film, a thin layer can be realised or, for example, a thick layer when enclosing liquids.

Advantageously, the layer used to seal the film into a laminate is made of an LDPE or an LLDPE. Low density polyethylene (LDPE) is a thermoplastic made from the monomer ethylene. LDPE has more branches (on about 2% of the carbon atoms) than HDPE, so its intermolecular forces are weaker, its tensile strength is lower and its elasticity is higher. The side branches mean that the molecules are less densely packed and less crystalline, which is why the density is lower.

The production of LLDPE is initiated by transition metal catalysts, in particular Ziegler or Philips type catalysts. The actual polymerisation process can be carried out either in the solution phase or in gas phase reactors. As a rule, octene is the comonomer in the solution phase, while butene and hexene are copolymerised with ethylene in a gas phase reactor. LLDPE has a higher tensile strength and a higher impact and puncture resistance than LDPE. It is very flexible and expands under load. It can be used to produce thinner films that have better resistance to stress cracking. It has good resistance to chemicals. It has good electrical properties. However, it is not as easy to process as LDPE, has a lower gloss and a narrower range for heat sealing.

In a particularly favourable variant of the invention, the polyethylene film including the layer is formed entirely from polyethylene. Polyethylene (PE) is a thermoplastic produced by chain polymerisation of petrochemically produced ethylene. Polyethylene is semi-crystalline and non-polar. As a result, the film fulfils the requirements of the Plastics Pact, is based on a mono-material construction and is recyclable.

In an alternative variant of the invention, the film has at least one additional outer layer of ethylene-vinyl alcohol copolymer layer (EVOH) and/or polyamide (PA). This additional layer can be formed as an outer layer, to which the print adheres better due to the higher polarity of the outer layer. At the same time, this additional outer layer improves the heat deflection temperature and the stiffness of the film. For this purpose, the additional layer of EVOH and/or PA is particularly thin, so that the proportion of material in the overall film is particularly low and the film is considered a mono-material construction in terms of recycling.

In a variant of the invention, the film comprises at least one further outer layer for producing a matt film surface.

For example, the further outer layer has no fillers, the film having a haze value according to ASTM D1003 of more than 65%, preferably more than 75%, in particular more than 85%, due to the further outer layer.

The other outer layer has a thickness of more than 4 μm and/or less than 10 μm, for example.

For example, the additional outer layer can be arranged on the side of the film facing away from the print and/or visible from the outside. The matt surface gives the film a favourable appearance.

In an alternative variant of the invention, at least one of the layers can have a proportion of LLDPE in order to increase the elasticity and thus also the Elmendorf tear resistance of the film.

According to the invention, the process for producing a laminate comprises several steps. Firstly, various compositions of the polymer components are produced, which are then extruded to form a film web with at least seven, ideally nine layers. The polymer mixtures differ in terms of the respective layers and the barrier layer. According to the invention, at least one further functional intermediate layer is arranged between the outer layers and the barrier layer. Advantageously, the film web is stretched monoaxially in the machine direction, whereby the favourable properties with regard to the overall density below 0.99 g/cm³, transparency and printability, the stiffness and toughness as well as the barrier properties of the film are achieved. The film web can then be printed directly and laminated with a sealing layer.

Ideally, extrusion is carried out as blow extrusion, which favours the formation of advantageous film characteristics such as stiffness.

The film is produced by monoaxial stretching with a machine direction orientation (MDO) by heating the film to a temperature slightly below its melting point and stretching it in a specific orientation. Stretching can also take place directly after extrusion, where the film web is still at a temperature slightly below its melting point.

In an advantageous variant of the invention, the film is stretched monoaxially in the machine direction by more than a factor of 2.0, preferably by more than a factor of 3.0, in particular by more than a factor of 4.0 and/or stretched by less than a factor of 7.0, preferably by less than a factor of 6.5, in particular by less than a factor of 6.0. This gives the film an advantageous stiffness and a favourable transparency and at the same time the density of the film has a value of less than 0.99g/cm³.

According to the invention, the laminate is used as recyclable and oxygen-impermeable packaging, in particular as packaging for sensitive and perishable foodstuffs.

### BRIEF DESCRIPTION OF THE DRAWINGS

Further advantages and features of the invention are apparent from the description of an embodiment example with reference to drawings and from the drawings themselves. It shows

FIG. 1 shows a schematic structure of the laminate according to

the invention,

FIG. 2 a schematic structure of the laminate with an imprint in reverse printing design.

### DETAILED DESCRIPTION

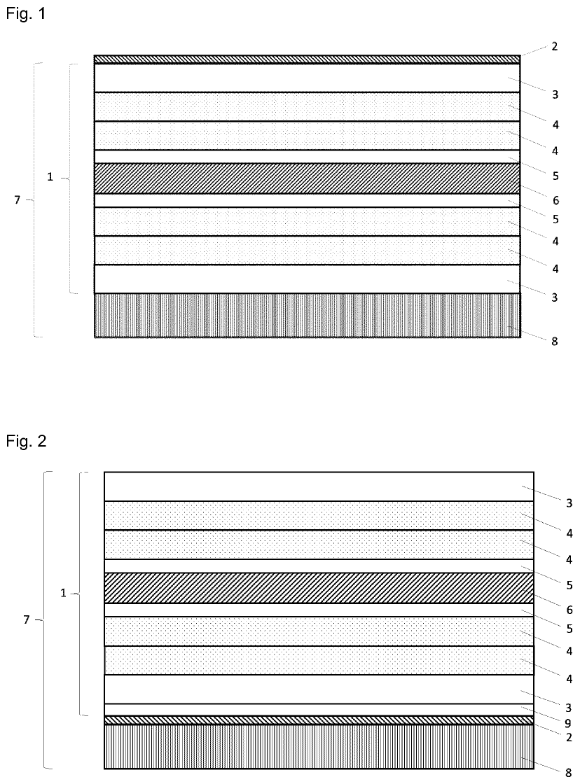

FIG. 1 shows a schematic structure of the laminate 7, which is formed from the film 1 and the layer 8. An imprint 2 is arranged directly on an outer layer 3 of the film 1. The imprint 2 is used to label the item to be packaged and for visual recognition as well as to support the brand image of the item brand.

In this embodiment, the film 1 is designed with nine layers in a symmetrical structure. The innermost layer is designed as a barrier layer 6 and consists of an ethylene-vinyl alcohol copolymer. The properties of the inner barrier layer 6 realise a film 1 with an oxygen transmission rate of less than 2 cm³/m³-day-bar, measured at 23° C. and 0% rH. In addition, the film 1 is virtually impermeable to water vapour due to the inner barrier layer 6 with a water vapour transmission rate of less than 5 g/m² in 24 h according to ASTM D6701-01. The thickness of the barrier layer 6 in this embodiment is approx. 14 μm before stretching.

The barrier layer 6 is surrounded by a tie layer 5 consisting of an LLDPE with a density of 0.910 g/cm³ and a melt flow rate (at 190° C. at 2.16 kg) of 2.5 g/10min according to ASTM D 1238. In this embodiment, the tie layer 5 is formed with a polyethylene grafted with maleic anhydride in order to realise an adhesion between the other polyethylene-based layers and the EVOH-based barrier layer 6. In this embodiment, the thickness of the tie layer 5 is approx. 8.5 μm before stretching.

Two functional intermediate layers 4 are arranged between the outer layers 3 and the tie layers 5, which realise the toughness despite the enormous stiffness of the film 1. The intermediate layers 4 consist entirely of a polyethylene whose density is 0.937 g/cm³ and whose melt flow rate (at 190° C. at 5 kg) is 2 g/10min according to ISO 1133. In this embodiment, the thickness of a functional intermediate layer 4 is approx. 14 μm before stretching.

The two outer layers 3 of the film 1 consist of an HDPE in addition to a proportion of additives. In the embodiment shown, the proportion of HDPE is 98% by weight and its density is 0.946 g/cm³ and its melt flow rate (at 190° C. at 5 kg) is 1.6g/10 min in accordance with ISO 1133.

In this embodiment, the layer thickness of the outer layers 3 before stretching is 15-17 μm, whereby the outer layer 3, which is arranged towards the imprint 2, is slightly thicker.

The nine-layer film 1 has a thickness of 120.5 μm after blow extrusion. After monoaxial stretching by a factor of 4.82, the thickness is 25 μm, with a density of 0.95 g/cm³. Layer 8 is formed from an LDPE.

FIG. 2 shows a further schematic structure of the laminate 7, which is formed from the film 1 and the layer 8. The film 1 and the layer 8 correspond to the illustration and description of FIG. 1. The print 2 is arranged directly on an outer layer 3 between the film 1 and the layer 8 and is applied using a reverse printing process.

In the embodiment shown in FIG. 2, the higher density polyethylene of the outer layers 3 and the outer intermediate layers 4 is designed as an HDPE whose density is 0.962 g/cm³ and whose melt flow rate (at 190° C. at 2.16 kg) is 0.85 g/10min according to ASTM 1238.

In addition, the film 1 has an optional outer layer 9, which is made of an ethylene-vinyl alcohol copolymer layer (EVOH). The imprint 2 adheres better to the additional outer layer 9 due to the higher polarity. In the embodiment shown, the thickness of the outer layer 9 after stretching is 4 μm and is formed from a SoarnoLT from Mitsubishi Chemicals.

1. A multilayer, monoaxially stretched, recyclable film (1) for a laminate (7), the film (1) comprising:
outer layers (3) and at least one inner barrier layer (6), and a tie layer (5) being arranged between the outer layers (3) and the at least one inner barrier layer (6); and
at least one further functional intermediate layer (4) being arranged between the outer layers (3) and the at least one inner barrier layer (6).

2. The film according to claim 1, wherein the outer layers (3) have a density which is a factor higher than the at least one functional intermediate layer, the value of the factor being more than 1.002and less than 1.20.

3. The film according to claim 1, wherein a density of the outer layers (3) has a value of more than 0.941 g/cm³.

4. The film according to claim 1, wherein a density of the at least one functional intermediate layer (4) has a value of more than 0.91 g/cm³ and of less than 0.940 g/cm³.

5. The film according to claim 1, wherein the at least one functional intermediate layer (4) comprise a bimodal polyethylene, wherein the bimodal polyethylene is a terpolymer, and further wherein the terpolymer is a bimodal ethylene/1-butene/C6-C12-alpha-olefin terpolymer.

6. The film according to claim 1, wherein a density of the the layer (5) has a value of less than 0.915 g/cm³.

7. The film according to claim 1, wherein the barrier layer (6) is formed as an ethylene-vinyl alcohol copolymer layer.

8. The film according to claim 1, wherein the tie layer (5) comprises a maleic anhydride modified polyethylene and a polyethylene, wherein a density of the tie layer (5) is more than 0.880g/cm³, preferably more than 0.900 g/cm³ and is less than 0.940 g/cm³ and has a melt flow rate (at 190° C. at 2.16 kg) according to ASTM D 1238 that is more than 0.1 g/10 min and is less than 5.0 g/10 min.

9. The film according to claim 1, wherein a melt flow rate (at 190° C. at 2.16 kg) according to ASTM D 1238 of the tie layer (5) is similar to a melt flow rate of the functional intermediate layer (4), wherein the melt flow rates of the tie layer (5) and the functional intermediate layer (4) differ by a factor of less than 1.5.

10. The film according to claim 1, wherein the film (1) has a gloss according to DIN EN ISO 2813 of less than 7%.

11. The film according to claim 1, wherein the film (1) has an oxygen transmission rate of less than 10 cm³/m³-day-bar, measured at 23° C. and 0% rH.

12. The film according to claim 1, wherein the film (1) has a water vapour transmission rate of less than 50 g/m² in 24 h according to ASTM D6701-01.

13. The film according to claim 1, wherein the film (1) is stretched monoaxially in a machine direction by more than a factor of 2.0 and is stretched in the machine direction by less than a factor of 7.0.

14. The film according to claim 1, wherein an imprint (2) is arranged directly on an outermost one of the outer layers (3) of the film (1).

15. The film according to claim 1, wherein the film (1) has a thickness of less than 60 μm, and more than 5 μm.

16. The film according to claim 1, wherein a density of the film (1) is less than 0.99 g/cm³, and iis more than 0.60 g/cm³.

17. The film according to claim 1, wherein the multilayer structure of the film (1) is symmetrical.

18. The film according to claim 1, wherein the film (1) has at least one additional, outer layer (9) which is formed from an ethylene-vinyl alcohol copolymer layer (EVOH) or from polyamide (PA).

19. The film according to claim 1, further comprising at least one further outer layer for producing a mattness which has no fillers, the film (1) thereby having a haze value according to ASTM D1003 of more than 65%.

20. The film according to claim 1, wherein at least one outer layer (3) has a proportion of polypropylene, the proportion being more than 5% by weight and less than 50% by weight.
